(19) United States
(12) Patent Application Publication
(10) Pub. No.: US 2006/0243948 A1
(43) Pub. Date: Nov. 2, 2006

(54) LIQUID CRYSTAL DISPLAY

(76) Inventors: Masaru Ishiwa, Kanagawa (JP); Takayuki Eiraku, Kanagawa (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(21) Appl. No.: 11/277,263

(22) Filed: Mar. 23, 2006

(30) Foreign Application Priority Data
Mar. 25, 2005 (JP) 2005-089776

(51) Int. Cl. C09K 19/34

(52) U.S. Cl. 252/299.61

(57) ABSTRACT

The invention relates to a liquid crystal display used as a display unit of an electronic apparatus and provides a small liquid crystal display having a thin picture frame, the display having an excellent cooling function, high luminance, and high color reproducibility. The liquid crystal display includes a rear frame having an upstanding portion formed by bending an end of a longer side thereof and a heat sink which is in thermal contact with the rear frame. Thus, heat generated at LEDs can be efficiently radiated. The liquid crystal display also includes a liquid crystal display panel driving circuit which is divided into a data substrate and a control substrate. The liquid crystal display can be provided in a compact structure having a thin picture frame by disposing the data substrate on a side surface of the liquid crystal display and disposing the control substrate on the side of the heat sink.

### BACKGROUND OF THE INVENTION

1. Field of the Invention

The present invention relates to a liquid crystal display used as a display unit of an electronic apparatus.

2. Description of the Related Art

While a majority of backlight units available on the market employ a cold cathode tube as a light source, backlight units employing LEDs have already been developed. Liquid crystal displays utilizing a backlight unit employing LEDs as a light source are provided on small electronic apparatus such as PDAs and portable telephones. Incidentally, high luminance power LEDs having a self-cooling function have been developed recently. Wide screen liquid crystal displays to be used as monitors equipped with a backlight unit employing power LEDs as a light source have already been made public in opportunities such as exhibitions.

Patent Document 1: JP-A-2002-040413

Backlight units utilizing cold cathode tubes and liquid crystal displays equipped with the same are limited in color reproducibility. Recently, people are becoming more concerned about environmental problems, and there is a tendency against cold cathode tubes in which mercury is used. Further, cold cathode tubes are liable to break because of their vulnerability to shock. Furthermore, driving a cold cathode tube entails danger because it requires a voltage as high as several thousand volts. Recently, LEDs are attracting attention as backlight unit light sources to replace cold cathode tubes. LEDs are less liable to break and drivable at a low voltage, and they are components less harmful to environment because they involve no mercury. LEDs can therefore remedy the shortcomings of cold cathode tubes. In the field of small electronic apparatus such as PDAs and portable telephones, products employing liquid crystal displays equipped with a backlight unit having LEDs as light sources have already become available.

The light output of an LED is substantially proportionate to the amount of a current passed through the same. However, the light output of an LED is limited because it is difficult to pass a great current through the LED which is a chip type component. Liquid crystal displays to be used in monitors or notebook computers are required to have a wide screen and high luminance, and LEDs are therefore light source unsuitable for a backlight unit of such a liquid crystal display. Incidentally, high luminance power LEDs having a self-cooling function have recently been developed, and development is also active on liquid crystal displays employing such LEDs as light sources of a backlight unit to be used for wide screen monitors. However, even an LED having a self-cooling function must essentially have other cooling measures because the cooling function alone is insufficient in effect. It is especially difficult to cool a light source of a backlight unit for a monitor or notebook computer which must have a small size or thin picture frame. For example, a backlight unit will be oversized when forced air cooling is performed using a fan. Further, a trouble with the fan or clogging of a filter used therein will necessitate a great amount of labor for replacement or cleaning of the fan. In the case of liquid cooling, a coolant is needed, and there is a possibility of leakage of the liquid. The leakage of the liquid can result in an environmental problem when a coolant other than water is used.

### SUMMARY OF THE INVENTION

It is an object of the invention to provide a small-sized liquid crystal display with a thin picture frame which has an excellent cooling function, high luminance, and high color reproducibility.

The above-described object is achieved by a liquid crystal display characterized in that it comprises a frame member including a rear frame having an upstanding portion at least in a part of the periphery thereof and a front frame provided opposite to the rear frame, a liquid crystal display panel provided by sealing a liquid crystal between substrates provided opposite to each other, a light source provided at the upstanding portion, a light guide body for guiding light from the light source to the liquid crystal display panel, a reflective sheet for effectively utilizing light exiting the light guide body, a diffusing member for controlling the exiting direction of the exiting light, an optical sheet, a cosmetic cover cooperating with the frame member to hold and accommodate the liquid crystal display panel, the light source, the light guide body, the reflective sheet, the diffusing member, and the optical sheet, a liquid crystal display panel driving circuit for driving the liquid crystal display panel, and a light source driving power supply for supplying power to the light source to drive the same.

The invention makes it possible to provide a small-sized liquid crystal display with a thin picture frame which has an excellent cooling function, high luminance, and high color reproducibility.

### BRIEF DESCRIPTION OF THE DRAWINGS

FIGS. 1A and 1B are perspective views of a liquid crystal display 1 in a mode for carrying out the invention;

FIG. 2 is an exploded perspective view of the liquid crystal display 1 in the mode for carrying out the invention;

FIG. 3 is a sectional view of the liquid crystal display 1 in the mode for carrying out the invention;

FIGS. 4A and 4B are sectional views of a liquid crystal display 1 according to an embodiment in the mode for carrying out the invention;

FIG. 5 is a perspective view of the liquid crystal display 1 according to the embodiment in the mode for carrying out the invention;

FIG. 6 is a perspective view of a liquid crystal display according to the related art as a comparative example;

FIG. 7 is an exploded perspective view of the liquid crystal display 1 according to the embodiment in the mode for carrying out the invention;

FIG. 8 is a view of the liquid crystal display 1 according to the embodiment in the mode for carrying out the invention showing the region indicated by an imaginary circle A in FIG. 7 in an enlarged scale;

FIGS. 9A to 9C are rear views of the liquid crystal display 1 according to the embodiment in the mode for carrying out the invention;

FIGS. 10A and 10B are perspective views of the liquid crystal display 1 according to the embodiment in the mode for carrying out the invention;

FIG. 11 is a perspective view of the liquid crystal display 1 according to the embodiment in the mode for carrying out the invention;

FIGS. 12A and 12B are views of the liquid crystal display 1 according to the embodiment in the mode for carrying out the invention showing the regions indicated by imaginary circles A and B in FIG. 11;

FIGS. 13A and 13B are perspective views of the liquid crystal display 1 according to the embodiment in the mode for carrying out the invention; and

FIG. 14 is a perspective view of a monitor equipped with a liquid crystal display 1 according to the embodiment in the mode for carrying out the invention.

### DESCRIPTION OF THE PREFERRED EMBODIMENT

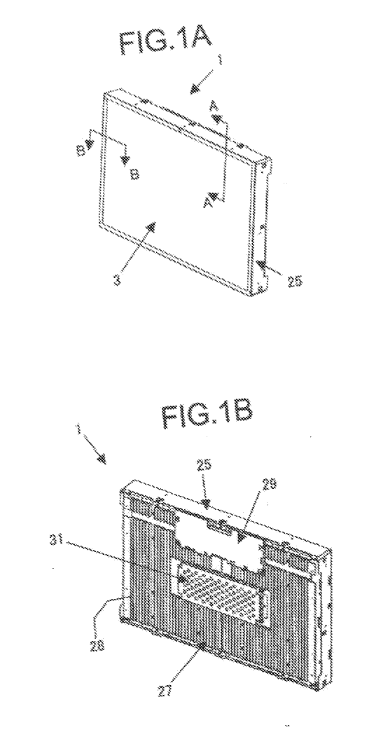

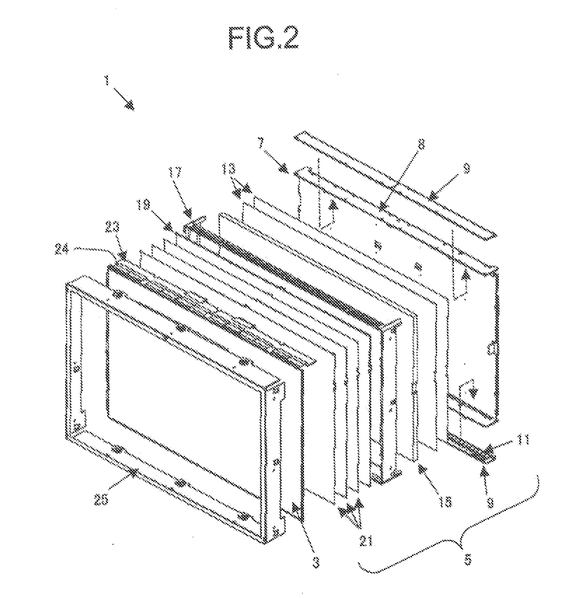

A liquid crystal display in a mode for carrying out the invention will now be described with reference to FIGS. 1A to 14. First, a schematic configuration of a liquid crystal display 1 in the present mode for carrying out the invention will be described with reference to FIGS. 1A, 1B and 2. FIG. 1A is a perspective view of the liquid crystal display 1 taken from the side of a display screen thereof, and FIG. 1B is a perspective view of the liquid crystal display 1 taken from the rear side of the display screen. FIG. 2 is an exploded perspective view of the liquid crystal display 1. As shown in FIGS. 1A, 1B, and 2, the liquid crystal display (liquid crystal display unit) 1 includes a liquid crystal display panel 3 provided by sealing a liquid crystal between two substrates provided opposite to each other and a backlight unit 5 provided on the back of the liquid crystal display panel 3. High luminance power LEDs 11 having a self-cooling function are used as a light source of the backlight unit 5. The backlight unit 5 has a side edge type structure in which the LEDs 11 are provided on a side of a light guide body 15.

A frame member includes a rear frame 7 and a front frame 17. The rear frame 7 has upstanding portions 8 formed by bending side edges along longer sides of the same. While the upstanding portions 8 of the present embodiment are formed on both longer sides of the rear frame 7, such a portion may be formed at least in a part of the periphery of the rear frame 7 (on at least one of the four sides of the frame). As indicated by broken lines in FIG. 2, LED modules (light source modules) 9 are disposed on surfaces of the two upstanding portions 8 facing each other, the LED modules being formed in a thin rectangular shape, and a plurality of the LEDs 11 being mounted on the modules.

A light guide body 15 for guiding light emitted by the LEDs 11 to the liquid crystal display panel 3 and two reflective sheets 13 used for allowing effective utilization of light exiting the light guide body 15 are provided between the rear frame 7 and the front frame 17. A diffusing member 19 for controlling the direction of the light emitted by the LEDs 11 and three optical sheets 21 are disposed between the light guide body 15 and the liquid crystal display panel 3. The optical sheets 21 have a function of making the color and quantity of light uniform in a plane by mixing beams of light traveling at different angles to perform angular re-alignment of the beams at one point in the plane. A data substrate 23 having a plurality of drive ICs 24 mounted thereon for driving the liquid crystal display panel 3 is provided on one side of the liquid crystal display panel 3 in the longitudinal direction thereof.

A cosmetic cover 25 is provided on a display screen side of the liquid crystal display panel 3. The cosmetic cover 25 cooperates with the frame member to hold and accommodate the liquid crystal display panel 3, the light source modules 9, the light guide body 15, the reflective sheets 13, the diffusing member 19, and the optical sheets 21.

The rear frame 7 is formed from a material having relatively high thermal conductivity such as aluminum. As shown in FIG. 1B, a heat sink 27, which is in thermal contact with the rear frame 7, is disposed on a rear side of the liquid crystal display 1. Securing elements such as screws (not shown) are provided in the vicinity of positions where the LED modules 9 are mounted to the rear frame 7. The use of the securing elements allows the liquid crystal display 1 to be secured to a frame portion of a monitor (external apparatus).

The heat sink 27 has a plurality of radiation fins 28 extending in the transverse direction of the liquid crystal display 1. Referring to FIG. 1B, the heat sink 27 has regions where no radiation fin 28 is formed in a central part thereof an in a part above the central part. An LED driving power supply (light source driving power supply) 31 for supplying power to drive the LEDs 11 is mounted in the central region, and a control substrate 29 having a control circuit mounted thereon for controlling the driver ICs 24 is mounted in the region above the central part. The control substrate 29 and the data substrate 23 (see FIG. 2) are divisions of a liquid crystal display panel driving circuit.

In the liquid crystal display 1, an optical sensor (not shown) for detecting light from the backlight unit 5 to control luminance and chromaticity of the same is disposed substantially in the middle of the rear frame 7.

As described above, the liquid crystal display 1 in the present mode for carrying out the invention includes the backlight unit 5 in which the high luminance power LEDs 11 having a self-cooling function are used as light sources. It is therefore possible to provide a liquid crystal display 1 which has high luminance and high color reproducibility and which is less harmful to environment in that no mercury is used. Further, since the backlight unit 5 has a side edge type structure, the liquid crystal display 1 can be provided with a small thickness. The rear frame 7 is formed from a material having relatively high thermal conductivity such as aluminum. Further, since the heat sink 27 is disposed in thermal contact with the rear frame 7, the liquid crystal display 1 can release heat generated by the LEDs 11 into the air with high efficiency. Thus, a need for a radiation fan is eliminated to allow the liquid crystal display 1 to be provided in a small size.

The securing elements such as screws are provided in the vicinity of positions where the LEDs 11 are mounted to the rear frame 7 to allow the display to be secured to a frame portion of a monitor, whereby the cooling function of the liquid crystal display 1 is further improved. The liquid crystal display panel driving circuit is divided into the data substrate 23 and the control substrate 29, and only the control substrate 29 is provided on the side of the heat sink 27 to reduce the area of the region where no radiation fin 28 is formed. It is therefore possible to provide the heat sink 27 with a great volume while maintaining a small picture frame width, whereby the liquid crystal display 1 is provided with an improved cooling function. Since the optical sensor for controlling luminance and chromaticity by detecting light from the backlight unit 5 and the LED driving power supply 31 are disposed substantially in the middle of the rear frame 7, the liquid crystal display 1 can be provided with high color reproducibility.

The liquid crystal display in the present mode for carrying out the invention will now be more specifically described with reference to an embodiment of the same.

### EMBODIMENT

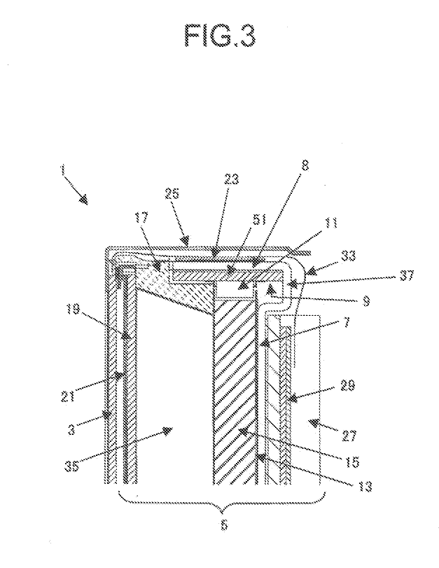

A liquid crystal display according to the present embodiment will now be described with reference to FIGS. 3 to 14. FIG. 3 is a sectional view of a liquid crystal display 1 taken along an imaginary line A-A in FIG. 1A. As shown in FIG. 3, a recess 37 is formed at an upstanding portion 8 of a rear frame 7. An LED module 9 is provided on a side of the upstanding portion 8 facing a light guide body 15. The LED module 9 includes a plurality of LEDs 11 and a circuit substrate 51 on which the plurality of LEDs 11 are mounted. The LEDs 11 and the light guide body 15 can be easily located by disposing the LED module 9 in a part of the recess 37. A data substrate 23 is provided between the upstanding portion 8 and a cosmetic cover 25. The data substrate 23 is electrically connected to a control substrate 29 through an FPC 33.

A diffusing member 19 is formed from a material having a high Young's modulus. A space 35 equivalent to the thickness of a front frame 17 is defined between the diffusing member 19 and the light guide body 15. For example, when red (R), green (G), and blue (B) LEDs are used, R, G, and B beams of light emitted by the respective LEDs are mixed in the light guide body 15 and the space 35, and predetermined white light exits from an optical sheet 21.

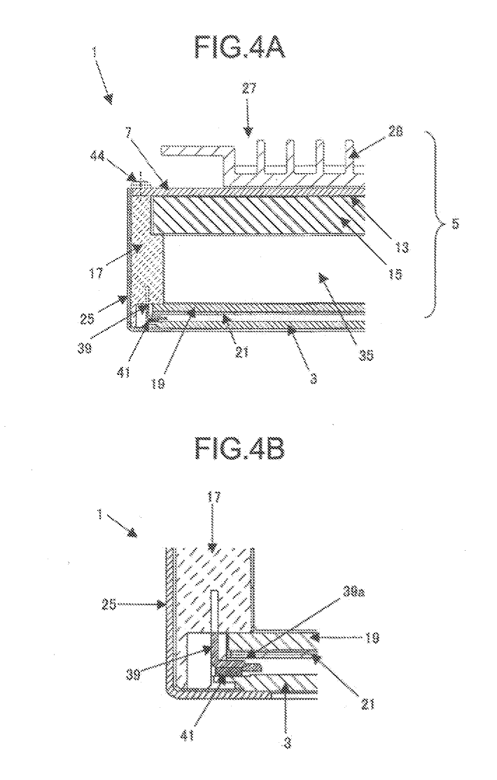

FIGS. 4A and 4B are sectional views of the liquid crystal display 1 taken along an imaginary lin B-B in FIG. 1A. FIG. 4A is a sectional view of the liquid crystal display 1 taken along the imaginary line B-B in FIG. 1A. FIG. 4B is an enlarged view of a corner of a liquid crystal display panel 3. As shown in FIG. 4A, the rear frame 7 and a front frame 17 are secured to each other with a screw 44 to provide a structure in which the frames 7 and 17 sandwich a reflective sheet 13 and the light guide body 15.

As shown in FIGS. 4A and 4B, the space 35 is provided on the side of the light guide body 15 where a light exit surface of the light guide body is located. A diffusing member 19 and optical sheets 21 are provided in the side of the space facing the light guide body 15. The diffusing member 19 and the optical sheets 21 are sandwiched by the front frame 17 and an L-shaped member 39. A part of the L-shaped member 39 is press-fit into the front frame 17 to be secured thereto. As shown in FIG. 4B, the L-shaped member 39 has a stepped portion 39a. A rubber spacer 41 is applied to a recessed part of the stepped portion 39a located on the side of the liquid crystal display panel 3. Thus, any displacement of the rubber spacer 41 can be prevented. When the L-shaped member 39 is produced by bending a sheet metal, it contacts the optical sheets 21 at a corner thereof which is a curved surface, which makes it possible to prevent any scratch on the optical sheets 21.

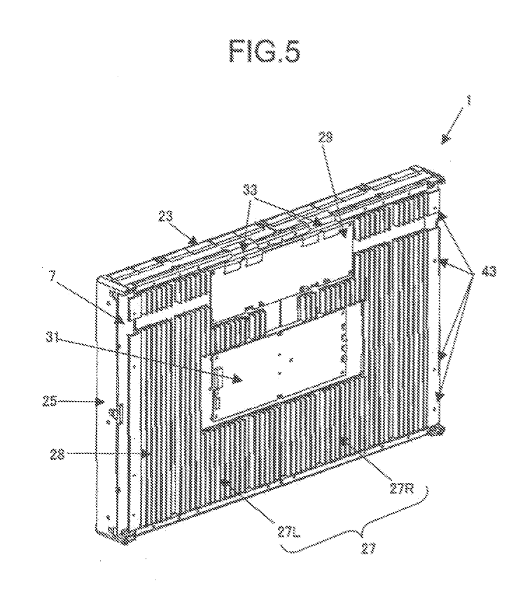

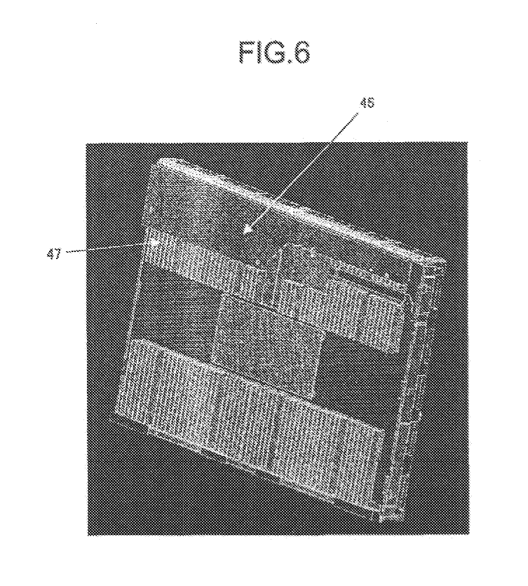

FIG. 5 is a detailed perspective view of the liquid crystal display 1 taken from the side of the heat sink 27. FIG. 6 is a perspective view of a liquid crystal display according to the related art as a comparative example, taken from the side of a heat sink 47 thereof. The liquid crystal display 1 includes a liquid crystal display panel driving circuit which has divisions constituted by the data substrate 23 and the control substrate 29. As a result, the data substrate 23 can be formed in a thin rectangular shape. It is therefore possible to dispose the data substrate 23 on a side surface of a backlight unit 5 and to dispose the control substrate 29 on the side of the heat sink 27 by folding the driving circuit as shown in FIG. 5 while keeping the data substrate 23 and the control circuit 29 connected to each other through FPCs 33. The liquid crystal display 1 can be thus provided with a thin picture frame.

As shown in FIG. 6, a liquid crystal display panel driving circuit 45 according to the related art is folded to be disposed on the side of the heat sink 47. The liquid crystal display panel driving circuit 45 is relatively large because it is provided by integrating a data substrate and a control substrate. Therefore, the liquid crystal display panel driving circuit 45 occupies a high percentage of the total area of the heat sink 47. Since no radiation fan can be formed in the position where the liquid crystal display panel driving circuit 45 is disposed, it is difficult for the heat sink 47 of the liquid crystal display according to the related art to release heat sufficiently.

On the contrary, the liquid crystal display 1 of the present embodiment includes the liquid crystal display panel driving circuit having the data substrate 23 and the control substrate 29 which are separated from each other as shown in FIG. 5. The size of the control substrate 29, which is folded toward the heat sink 27 to be disposed on the rear side of the liquid crystal display 1, is therefore smaller than the size of the liquid crystal display panel driving circuit 45 according to the related art. Consequently, the control substrate 29 occupies a smaller percentage of the total area of the heat sink 27 when compared to the percentage occupied by the circuit in the liquid crystal display according to the related art. Thus, radiation fins 28 are formed in an area greater than the area of the fins of the liquid crystal display according to the related art. As thus described, the radiation fins 28 of the liquid crystal display 1 can be provided with a great volume, and the heat sink 27 can provide with an improved cooling function.

Further, screw holes 43 for fastening are provided on the heat sink 27 to be used as mounting holes for mounting the liquid crystal display 1 to a monitor (not shown), which allows a part of heat generated at the LEDs 11 (not shown in FIG. 5) to be radiated at the monitor. Thus, the cooling function of the liquid crystal display 1 is improved. While the heat sink 27 of the present embodiment is extrusion and formed as left and right heat sinks 27L and 27R separate from each other, it may alternatively be formed integrally as an aluminum die-cast to achieve uniformity of heat.

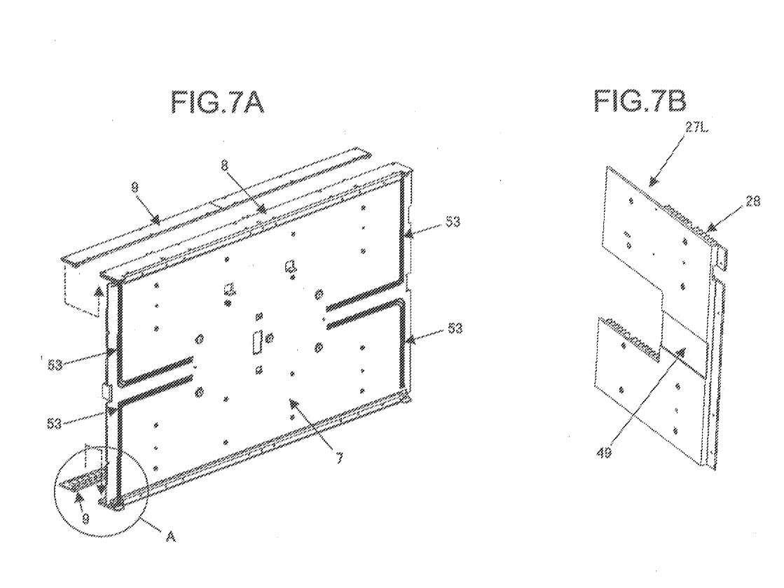

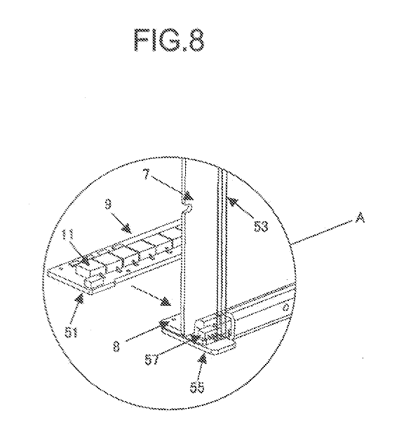

FIG. 7 is an exploded perspective view of the rear frame 7 with the heat sink 27 removed. In FIG. 7, the heat sink 27 is represented only by the left heat sink 27L which is disposed on the left side of the rear frame 7. FIG. 8 is an enlarged view of the region enclosed by an imaginary circle A in FIG. 7. As shown in FIG. 7, LED wirings (light source wirings) 53 connected to a light source driving power supply (not shown) are disposed between the heat sink 27 and the rear frame 7. A recess 49 is formed on a surface of the heat sink 27L facing the rear frame 7, and the LED wirings 53 are routed in the recess 49 and are extended to an end (a shorter side) of the rear frame 7 where no LED module 9 is disposed. The LED wirings 53 are disposed along the shorter side of the rear frame 7 and connected to the LED modules 9.

In a structure in which the LED wirings 53 are extended to the neighborhoods of left and right intermediate parts of the rear frame 7 (the neighborhoods of the centers of the longer sides of the frame), it is necessary to provide holes in the rear frame 7 to allow the LED wirings 53 to pass. As a result, the holes disturb the uniformity of heat at upstanding portions 8 of the rear frame 7, which can consequently disturb the uniformity of heat in the transverse direction of the LED modules 9. Thus, variation can occur in the emission and life of the LEDs 11. In the present embodiment, since there is no need for providing the rear frame 7 with holes to allow the LED wirings 53 to pass, the uniformity of heat at the LED modules 9 can be maintained.

As shown in FIG. 8, protrusions 55 are provided at corners of the rear frame 7 such that they contact the upstanding portions 8. The LED wirings 53 and connectors 57 connected to the LED wirings 53 are protected by the protrusions 55.

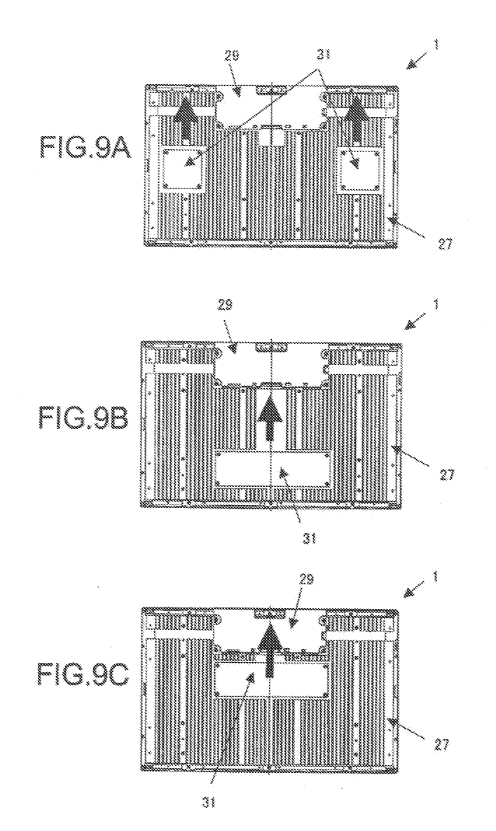

FIGS. 9A to 9C are views of the liquid crystal displays taken from the side of the heat sink 27. As indicated by thick arrows in FIGS. 9A to 9C, heat generated at the LED driving power supply 31 climbs up due to a tunnel effect. As a result, if the LED driving power supply 31, which is one of sources of the heat, is located in the middle of the rear frame 7, the temperature of the liquid crystal display 1 tends to become higher in the middle of a longer side thereof. The increase in the temperature of the liquid crystal display 1 in the middle of the longer side can be suppressed by dividing the LED driving power supply 31 into left and right parts disposed on both ends of the display as shown in FIG. 9A. Alternatively, the LED driving power supply 31 may be disposed rightward or leftward from the center of the longer side instead of dividing the same.

The temperature of the liquid crystal display 1 tends to be higher at the top part of the same than the bottom part. Therefore, the top part of the liquid crystal display 1 can be made less vulnerable to the heat from the LED driving power supply 39 by disposing the LED driving power supply 39 in the bottom part of the display 1 as shown in FIG. 9B.

Further, the LED driving power supply 31 may alternatively be disposed in the top part of the liquid crystal display 1 as shown in FIG. 9C to allow the heat generated at the LED driving power supply 31 to be quickly released to the outside from the top part of the liquid crystal display 1 by taking advantage of the ascending nature of heat.

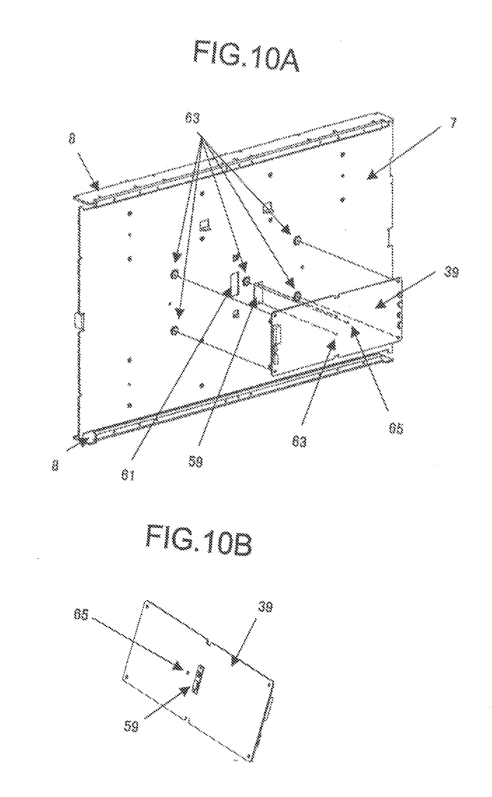

FIGS. 10A and 10B are perspective views of major parts of a liquid crystal display 1 which is provided with a color sensor (optical sensor) 59 for detecting light emitted by LEDs. FIG. 10A is an exploded perspective view of the rear frame 7 with an LED driving power supply 39 removed. FIG. 10B is a perspective view of the LED driving power supply 39 with the optical sensor 59 mounted thereon. As shown in FIG. 10A, the color sensor 59 is disposed substantially in the middle of the rear frame 7. A light detecting hole 61 slightly smaller than the color sensor 59 is formed substantially in the middle of the rear frame 7. Light emitted by the LEDs (not shown) disposed on the upstanding portions 8 exits the light detecting hole 61, and the luminance and chromaticity of the liquid crystal display 1 can be controlled by detecting the exiting light with the color sensor 59.

As shown in FIG. 10B, the color sensor 59 is mounted on the LED driving power supply 39 to allow feedback of a detection signal to be quickly provided to the LED driving power supply 39. The color sensor 59 must be positioned at accuracy expressed in 1/10 mm. Therefore, any warp of the printed circuit board (PCB) that constitutes the LED driving power supply 39 attributable to heat cannot be ignored. Under the circumstance, as shown in FIG. 10A, the LED driving power supply 30 is screwed to the rear frame 7 by forming a separate screw hole 65 in the vicinity of screw holes 63 for mounting the color sensor 59 to the LED driving power supply 39, which makes it possible to minimize the influence of any warp of the PCB constituting the LED driving power supply 39 on the color sensor 59.

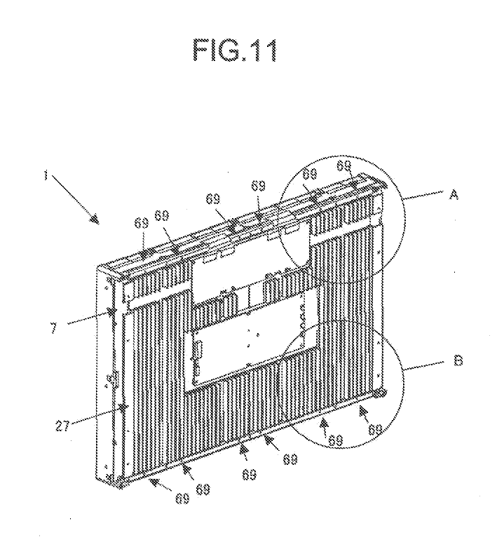

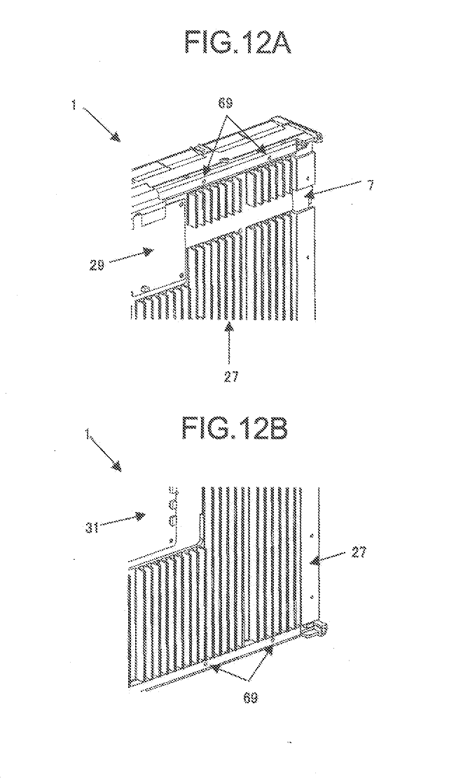

FIG. 11 is a perspective view of the liquid crystal display 1 taken from the side of the heat sink 27. FIGS. 12A and 12B are enlarged views of the regions indicated by imaginary circles A and B in FIG. 11, respectively. FIG. 12A is an enlarged view of the region of the imaginary circle A in FIG. 11, and FIG. 12B is an enlarged view of the region of the imaginary circle B in FIG. 11. As shown in FIGS. 11 to 12B, a plurality of screw holes 69 (securing elements) are formed in the vicinity of ends of both longer sides of the rear frame 7 to which the LED modules 9 (not shown in FIGS. 11 to 12B) are mounted. The liquid crystal display 11 can be secured to a frame portion of a monitor using the screw holes 69. When the display is mounted in a housing of a monitor, heat can be radiated into the air by transferring the same not only to the cooling element (heat sink 27) of the liquid crystal display 1 but also to the housing of the monitor. By this, it is possible to improve the cooling capacity of the liquid crystal display 1.

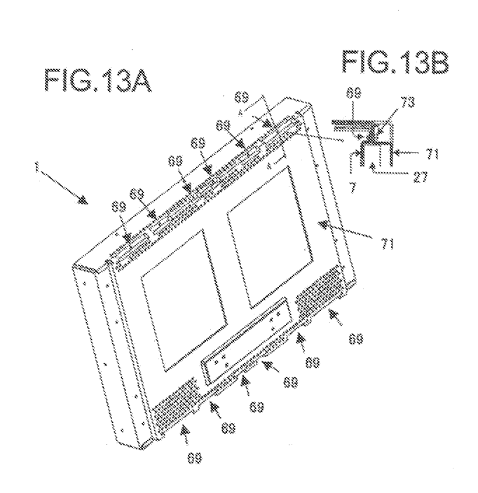

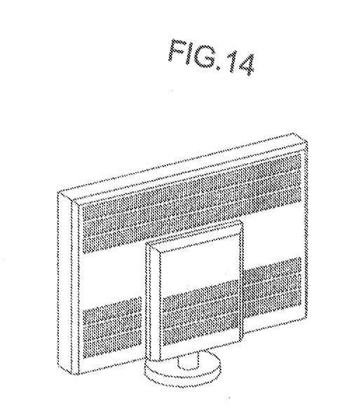

FIGS. 13A and 13B show how a chassis 71 of a monitor is mounted to the liquid crystal display 1 using the screw holes 69. FIG. 13A is a perspective view of the liquid crystal display 1 taken from the rear side thereof. FIG. 13B is an enlarged view of a section taken along an imaginary line A-A in FIG. 13A. FIG. 14 is a perspective view of the monitor taken from the rear side thereof. As shown in FIGS. 13A and 13B, the rear frame 7 and the chassis 71 of the monitor are secured to each other by engaging the screw holes 69 with screws 73. Since the rear frame 7 and the chassis 71 can be put in thermal contact with each other as thus described, heat generated at the liquid crystal display 1 can be efficiently conducted to the monitor.

As described above, high luminance power LEDs 11 can be used as light sources of the liquid crystal display 1 of the present embodiment because the display has an excellent cooling function. As a result, the liquid crystal display 1 can achieve display characteristics excellent in terms of luminance and color reproducibility by making effective use of light. Further, the liquid crystal display 1 can be provided with a compact structure having a thin picture frame because there is no need for a radiation fan. Furthermore, the liquid crystal display 1 sufficiently confronts environmental problems in that it does not employ a cold cathode tube utilizing mercury.

What is claimed is:

1. A liquid crystal display comprising:
a frame member including a rear frame having an upstanding portion at least in a part of the periphery thereof and a front frame provided opposite to the rear frame;
a liquid crystal display panel provided by sealing a liquid crystal between substrates provided opposite to each other;
a light source provided at the upstanding portion;
a light guide body for guiding light from the light source to the liquid crystal display panel;
a reflective sheet for effectively utilizing light exiting the light guide body;
a diffusing member for controlling the exiting direction of the exiting light;
an optical sheet;
a cosmetic cover cooperating with the frame member to hold and accommodate the liquid crystal display panel, the light source, the light guide body, the reflective sheet, the diffusing member, and the optical sheet;
a liquid crystal display panel driving circuit for driving the liquid crystal display panel; and
a light source driving power supply for supplying power to the light source to driving the same.

2. A liquid crystal display according to claim 1, wherein the reflective sheet, the light guide body, the diffusing member, the optical sheet, and the liquid crystal display panel are disposed on a top surface of the rear frame.

3. A liquid crystal display according to claim 1, wherein the reflective sheet and the light guide body are sandwiched by the rear frame and the front frame.

4. A liquid crystal display according to claim 1, wherein a space is provided on a side of a light exit surface of the light guide body and wherein the diffusing member, the optical sheet, and the liquid crystal display panel are disposed on the side of the light exit surface, the space being interposed between the elements and the surface.

5. A liquid crystal display according to claim 1, wherein the liquid crystal display panel driving circuit and the light source driving power supply are disposed on the rear frame.

6. A liquid crystal display according to claim 1, wherein the rear frame is formed from a material having high thermal conductivity.

7. A liquid crystal display according to claim 6, wherein the rear frame is formed from an aluminum material.

8. A liquid crystal display according to claim 1, wherein the upstanding portion has a recess and wherein a light source module having the light source mounted thereon is disposed in a part of the recess.

9. A liquid crystal display according to claim 8, wherein the recess allows the light source and the light guide body to be located.

10. A liquid crystal display according to claim 1, further comprising a heat sink disposed on the rear frame.

11. A liquid crystal display according to claim 10, wherein the liquid crystal display panel driving circuit is mounted in a location where a radiation fin of the heat sink is not formed.

12. A liquid crystal display according to claim 10, wherein the heat sink has a screw hole for securing and wherein the screw hole is a mounting hole for mounting to an external apparatus.

13. A liquid crystal display according to claim 10, wherein a light source wiring connected to the light source driving power supply is disposed between the heat sink and the rear frame, extended to an end of the rear frame where the light source is not provided, and connected to the light source.

14. A liquid crystal display according to claim 10, wherein the heat sink is an integral unit.

15. A liquid crystal display according to claim 13, wherein the rear frame has a protective protrusion for protecting a connector and the light source wiring provided at a part where the light source wiring is let out.

16. A liquid crystal display according to claim 1, wherein the rear frame has a securing element provided in the vicinity of the mounting position of the light source to allow the frame to be secured to a frame portion of an external apparatus.

17. A liquid crystal display according to claim 16, wherein the securing element is a screw hole.

18. A liquid crystal display according to claim 1, wherein the liquid crystal display panel driving circuit includes a data substrate on which a drive IC for driving the liquid crystal display panel is mounted and a control substrate on which a control circuit is mounted and which is separated from the data substrate.

19. A liquid crystal display according to claim 1, comprising a L-shaped member which cooperates with the front frame to sandwich the diffusing member and the optical sheet.

20. A liquid crystal display according to claim 19, wherein the L-shaped member can be press-fit into the front frame.

21. A liquid crystal display according to claim 19, wherein the L-shaped member has a stepped portion and wherein a rubber spacer is applied to the stepped portion.

22. A liquid crystal display according to claim 19, wherein the L-shaped member is formed by bending a sheet metal.

23. A liquid crystal display according to claim 1, comprising an optical sensor for detecting light from the light source.

24. A liquid crystal display according to claim 23, wherein the optical sensor is disposed substantially in the middle of the rear frame.

25. A liquid crystal display according to claim 23, wherein optical sensor is mounted on the light source driving power supply.

26. A liquid crystal display according to claim 25, wherein the light source driving power supply includes a securing element for securing itself to the rear frame in the vicinity of the mounting position of the optical sensor.

27. A liquid crystal display according to claim 1, wherein the light source driving power supply is provided substantially in the middle of the rear frame.

28. A liquid crystal display according to claim 1, wherein the light source driving power supply is provided in the vicinity of the periphery of the rear frame.

29. A liquid crystal display according to claim 1, comprising a couple of the light source driving power supplies, wherein the light source driving power supplies are provided in the neighborhoods of opposite ends of the rear frame, respectively.
